(19) United States
(12) Patent Application Publication
(10) Pub. No.: US 2004/0076763 A1
(43) Pub. Date: Apr. 22, 2004

(54) Apparatus and method for forming a thin flim

(76) Inventors: Hiroya Kirimura, Kyoto-Shi (JP); Kiyoshi Kubota, Kyoto-shi (JP); Masatoshi Onoda, Uzi-shi (JP); Naoto Kuratani, Kameoka-Shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/663,673

(22) Filed: Sep. 17, 2003

(30) Foreign Application Priority Data
Sep. 20, 2002 (JP) 2002-274199
Jan. 29, 2003 (JP) 2003-020163

(51) Int. Cl. B05D 1/08; H05H 1/26; B05C 5/00

(52) U.S. Cl. 427/446; 118/715; 118/620

(57) ABSTRACT

An apparatus for forming a thin film on an article, wherein a film-forming gas is supplied from a gas supplying device to a vacuum container which can be evacuated by an exhausting device to reduce gas pressure in the container, an electric power is applied from a power applying device to the film-forming gas to produce plasma from the gas in which the thin film is formed on the article disposed in the vacuum container. The gas supplying device includes a gas supply member having a gas supply surface portion opposed to a film-forming surface of the article in the vacuum container. The gas supply member has a plurality of gas supply holes dispersedly formed at the gas supply surface portion. The power applying device includes a power applying electrode in the vacuum container, the electrode being disposed as surface portion opposed to the article. The apparatus is capable of forming a thin film of high quality having a uniform thickness at a high deposition rate at an increased plasma density without increase of plasma potential.

### CROSS-REFERENCE TO RELATED APPLICATION

This application is based on Japanese patent applications No.2002-274199 filed in Japan on Sep. 20, 2002 and No.2003-20163 filed in Japan on Jan. 29, 2003, the entire contents of which are hereby incorporated by reference.

### BACKGROUND OF THE INVENTION

1. Field of the Invention

The present invention relates to an apparatus and a method for forming a thin film on an article to be covered with the film (hereinafter referred to as “an article to be film-covered”). More specifically, the invention concerns with an apparatus and a method for forming a thin film on a substrate, examples of the thin film being a crystalline silicon film, a silicon oxide film, or a silicon nitride film useful, e.g., for providing TFTs (thin film transistors) disposed in each pixel on a display device, and a silicon containing film to be used for a solar battery.

2. Description of Related Art

A plasma CVD method is widely known for forming a thin film on an article to be film-covered. A capacity coupling type parallel plated plasma CVD apparatus is widely known for conducting the plasma CVD method.

The plasma CVD apparatus is capable of forming a thin film on an article to be film-covered in a vacuum container, wherein an electric power is applied from a power applying device (usually a high frequency power applying device) to a film-forming gas fed from a gas supplying device to produce plasma from the gas, the gas being fed into the vacuum container which can be evacuated by an exhausting device to reduce gas pressure in the container so that in the plasma, a thin film is formed on the article to be film-covered in the vacuum container.

In the case of the parallel plated plasma CVD apparatus, the vacuum container accommodates a plate-like electrode for applying an electric power, which is connected to a power source, and an opposed plate-like electrode (usually grounded electrode) supporting the article to be film-covered, and a film-forming gas introduced between the electrodes is made into plasma by an electric power applied across the electrodes, whereby a thin film is formed on the article to be film-covered in the plasma.

Such parallel plated plasma CVD apparatus may have a plate-like electrode for applying an electric power which is not intended to support the article to be film-covered and has numerous gas supply holes so dispersedly formed that even when a film-forming surface of the article to be film-covered has a large area, a film as uniform as possible can be formed over the entire surface thereof, e.g. as disclosed in Japanese Unexamined Patent Publication No.6-291054(291054/1994).

Japanese Unexamined Patent Publication No.1-216523(216523/1989) discloses that an alternating electric field or periodic pulse electric field is applied to a substrate on which a film is formed or its vicinity, each of the fields having a frequency allowing feed of a kinetic energy to both electrons and ion particles generated by plasma decomposition in order to form an amorphous semiconductor film of high quality by the parallel plated plasma CVD apparatus.

In the case of parallel plated plasma CVD apparatus, plasma density needs to be increased to form a film at a high deposition rate. One of methods of increasing the plasma density is to apply an increased power for producing plasma from the gas.

However, an increase of power to be applied raises an electric potential of the plasma. When the plasma potential is raised, the charged particles in the plasma are made to collide with the article to be film-covered at a high speed, the interface between the film and the article is damaged and the properties of the film are deteriorated.

As described above, it is difficult to increase deposition rate and to enhance quality of film at the same time.

The Japanese Unexamined Patent Publication No.1-216523(216523/1989) attempts to overcome this problem, but the attempt is not put into practical use.

Further, the gas pressure in the vacuum container is to be held high in a certain degree to retain the plasma in the vacuum container. But at a high gas pressure, the gas is not sufficiently made into plasma, whereby non-decomposed gas is left, making it difficult to increase the plasma density to the desired level. The insufficiency of plasma density results in failure to form a high quality film. When an increased overcome this issue, the foregoing problem is raised.

### SUMMARY OF THE INVENTION

An object of the invention is to provide an apparatus for forming a thin film, wherein a film-forming gas is supplied from a gas supplying device to a vacuum container which is evacuated by an exhausting device to reduce gas pressure in the container, and an electric power is applied from a power applying device to the gas to produce plasma from the gas wherein a thin film is formed on an article to be film-covered in the vacuum container, the apparatus being capable of forming a thin film of high quality at a high deposition rate and at an increased plasma density without raising plasma potential; and a method for forming a thin film using the above-mentioned apparatus, the method being capable of forming a thin film of high quality at a high deposition rate and at an increased plasma density without raising plasma potential.

The inventors conducted extensive research to achieve the foregoing object and found the following.

A gas supplying device to be used is one including a gas supply member having a gas supply surface portion wherein a plurality of gas supply holes are dispersedly formed, the gas supply surface portion being opposed to a film-forming surface of an article to be film-covered. A power applying device to be used is one having an electrode(s) for applying an electric power, the electrode being disposed in opposition to a space between the article to be film-covered and the opposed gas supply surface portion of the gas supply member and disposed in a surrounding region around the space.

When an electric power is applied from a power source to the electrode, a plasma can be maintained at a low gas pressure without supplying markedly increased power as in the conventional parallel plated plasma CVD apparatus, namely a high density plasma can be generated while suppressing increase of plasma potential, whereby a thin film of high quality can be formed at a high deposition rate.

Based on these findings, the invention provides an apparatus for forming a thin film, wherein a film-forming gas is supplied from a gas supplying device to a vacuum container(vacuum chamber) which is evacuated by an exhausting device to reduce gas pressure in the container, and an electric power is applied from a power applying device to the film-forming gas to convert the gas into plasma in which a thin film is formed on an article to be film-covered disposed in the vacuum container.

The gas supplying device includes a gas supply member having a gas supply surface portion, the gas supply surface portion being opposed to a film-forming surface of the article to be film-covered disposed in the vacuum container. The gas supply member has a plurality of gas supply holes dispersedly formed at the gas supply surface portion,

The power applying device includes a power applying electrode disposed in the vacuum container, the power applying electrode being disposed in a surrounding region around a space between the article to be film-covered (the article to be film-covered which is disposed in the vacuum container) and the gas supply surface portion of the gas supply member opposed to the article.

The invention also provides a method for forming a thin film with use of such apparatus.

The article to be film-covered may be disposed, for example, on a support provided in the vacuum container in a way that the article is opposed to the gas supply surface portion of the gas supply member.

In the method for forming a thin film according to the invention, a film can be formed while retaining the gas pressure at 10⁻² Pa to 10 Pa in the space at the time of forming a film.

The foregoing and other objects, features, aspects and advantages of the present invention will become apparent from the following detailed description of the present invention and the accompanying drawings.

### BRIEF DESCRIPTION OF THE DRAWINGS

FIG. 1 is a view schematically showing a structure of an example(plasma CVD apparatus) of the apparatus for forming a thin film according to the present invention.

FIG. 2 is a plan view showing gas dispersing pipes and a power applying electrode as disposed in the apparatus shown in FIG. 1.

FIG. 3 shows the results of evaluating the uniformity of thickness of silicon films formed in Experimental Examples 1-1 and 1-2.

FIG. 4 shows the results of evaluating the uniformity of thickness of silicon oxide films formed in Experimental Examples 2-2 and 2-3.

### DESCRIPTION OF THE PREFERRED EMBODIMENTS

Embodiments of the invention will be described with reference to the drawings.

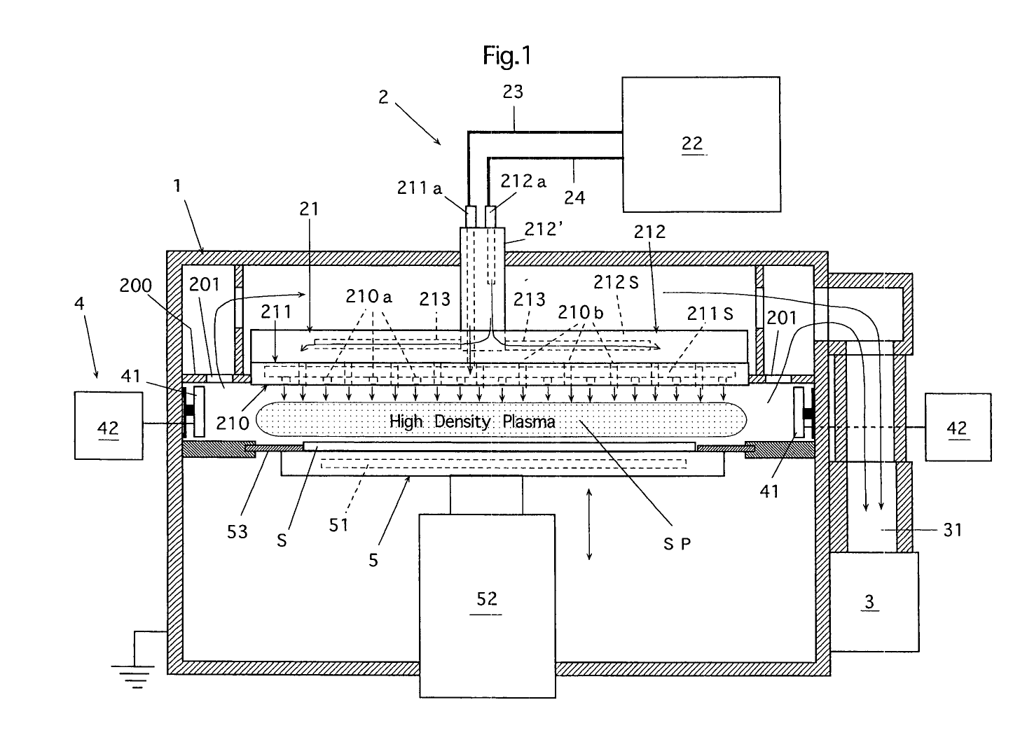

FIG. 1 is a view schematically showing structure of an example (plasma CVD apparatus) of the apparatus for forming a thin film according to the invention.

The apparatus for forming a thin film shown in FIG. 1 has a vacuum container(vacuum chamber) 1, a gas supplying device 2, an exhausting device 3, a power applying device 4 and a support 5 for holding an article to be film-covered.

The gas supplying device 2 in the illustrated example includes a gas supply member 21 disposed in an upper space in the vacuum container 1 and a gas supplying unit 22 for supplying a film-forming gas thereto.

In this example, the film-forming gas includes two or more kinds of gases.

The gas supplying unit 22 includes a plurality of gas sources(not shown) for forming a film, flow adjusting valves (not shown) for adjusting amount of gases to be supplied from the gas sources and open/close valves(not shown) for allowing or stopping supply of gas(es) from the gas sources. In the illustrated example, the gases are supplied through two gas ducts 23, 24 of a dual duct system to the gas supply member 21.

The support 5 is placed in a space below the member 21 in the vacuum container 1 in the illustrated example and can be opposed to the member 21 via a specified space SP during the operation of forming a thin film. The support 5 has a built-in heater 51 and can be moved upward and downward for connection and disconnection of the article to be film-covered (herein a substrate S for forming TFT's and the like) by reciprocatingly driving device (piston cylinder device in this example) 52.

On upward movement, the support 5 can be airtightly contacted with a ring-shaped member 53. The ring-shaped member 53 is airtightly fixed to the internal peripheral wall of the vacuum container 1. The support 5 is grounded via the vacuum container or the like.

The gas supply member 21 has a member 211 including a gas supply surface portion 210, and possesses a cover 212 which airtightly covers the member 211 on other side than the gas supply surface portion 210. The gas supply member 21 is in the shape of a plate as a whole although not limited thereto.

The gas supply surface portion 210 is opposed to and in parallel with the surface of the substrate S to be covered with a film and placed on the support 5. The gas supply surface portion 210 has numerous gas supply holes 210a dispersedly formed. The gas supply holes 210a are in communication with a space 211S formed in the member 211 for dispersion of gas. A gas guide duct 211a is connected to the member 211. The space 211S communicates with the gas duct 23 of dual gas duct system via the gas guide duct 211a.

The gas supply surface portion 210 has also numerous gas supply holes 210b dispersedly formed. The gas supply holes 210b pass through the member 211 for communication with a space 212S covered with the cover 212 and communicates with pipes 213 disposed therein for dispersion of gas.

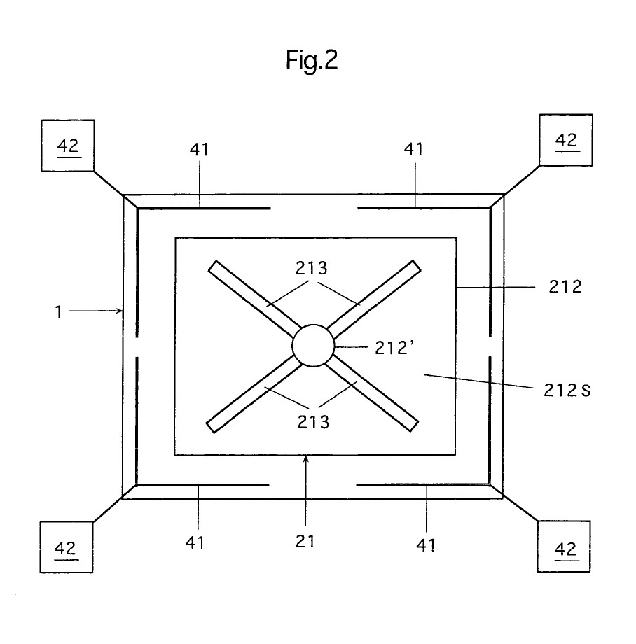

The pipes 213 are connected to a hollow gas guide member 212′ linked to the cover 212, and communicate with the other gas duct 24 via a gas guide duct 212a inserted in the gas guide member 212′. The pipes 213 are so disposed as to discharge the gas toward four corners in the space 212S covered with the cover 212 in a plan view as shown in FIG. 2.

The gas guide duct 211a passes through the gas guide member 212′. The gas guide member 212′ runs through a ceiling wall of the vacuum container 1 and is airtightly connected thereto. The gas supply member 21 is placed in the vacuum container 1 to leave substantially uniformly a space for gas discharge in a region of vicinity of periphery of the member 21.

More specifically, in the example of FIG. 1, a support 200 for supporting the member 21 is provided between the inside of side peripheral wall of the vacuum container 1 and the side peripheral wall of the member 211 having the gas supply surface portion 210. This structure leaves substantially uniformly a space for gas discharge in a region of vicinity of periphery portion of the gas supply member 21. The support 200 has a plurality of holes 201 substantially regularly spaced.

A proper plasma density can be obtained without immediately discharging the gas to be released into the space SP from the member 21 due to the structure in which the gas is discharged from the region of vicinity of the periphery portion of the gas supply member 21.

A discharge passage 31 is provided to discharge gas from the region of vicinity of the periphery of the gas supply member 21. The discharge passage 31 is connected to to the vacuum container 1, and the exhausting device 3 is connected to the passage 31. The gas can be discharged from the space around the gas supply member 21 via a plurality of discharge holes 201 formed in the support 200 and the discharge passage 31 to the exhausting device 3.

For example, members protruding in a radiating shape from the gas supply member 21 may be used in place of the support 200. In this case, a clearance between the radiating-type protruding members can be used for gas discharge.

The exhausting device 3 includes a turbo-molecular pump capable of discharge of gas for reduction of gas pressure in the container 1 so that the space SP between the gas supply member 21 and the substrate S disposed at a film-forming position can be adjusted to a gas pressure in a range of 10⁻² Pa to 10 Pa. By use of the turbo-molecular pump, the gas pressure of the space SP can be optionally reduced to as low as 10⁻² Pa. The exhausting device to be used is not limited to the type employing a turbo-molecular pump and may be one capable of reducing the pressure sufficiently.

The power applying device 4 includes, as shown in FIG. 4, electrodes 41 for applying an electric power and high frequency power sources 42 each connected to the electrodes 41, respectively. Each of the electrodes 41 is a plate folded in the shape of a mountain in a plan view as shown in FIG. 2.

The electrodes 41 are disposed in a quadrilateral shape surrounding the space SP as a whole in a plan view (when viewed in a plane). Each electrode 41 is fixed, as slightly spaced away, to the inner surface of the vacuum container 1 via an insulating material. The high frequency power sources 42 can simultaneously apply a power of specified high frequency to the corresponding electrodes 41. The power applying electrode(s) can be fixed, via an insulating material, over the inner surface of the vacuum container 1, whether it(they) may be of the type like the electrode 41 or of other type to be described later.

The high frequency power sources 42 are preferable when they are of the type providing a high frequency, e.g. as high as 60 MHz to reduce plasma potential.

The following description is given on a method for forming a thin film by the apparatus as described above.

First, the support 5 is moved downward and the substrate S to be film-covered is placed on the support S. The support 5 is moved upward to a film-forming position along with the substrate S. The periphery of the support 5 is airtightly contacted with the ring-shaped member 53 provided in the vacuum container. The substrate S is heated to a specified film-forming temperature by the heater 51 when so required.

Then, the gas pressure in the vacuum container 1 is reduced by the exhausting device 3, and a specified film-forming gas is introduced by the gas supplying device 2 into the space SP between the gas supply member 21 and the substrate S.

A high frequency power is applied to each of the electrodes 41 by the high frequency power sources 42 to form plasma from the introduced gas while retaining the gas pressure in the space SP in a range of approximately 10⁻² Pa to 10 Pa by the exhausting device 3. In this way, a thin film is formed on the substrate S. Although depending on the type of film to be formed, the gas pressure in the space SP may be in the range of approximately 10⁻² Pa to several Pa.

In this formation of a thin film, the film-forming gas is fed from the gas supply member 21 toward the substrate S in its entirety, so that a film of uniform thickness can be formed. Since the film can be formed under the gas pressure reduced to as low as approximately 10⁻² Pa to 10 Pa in the space SP, the film of so uniform thickness can be easily formed.

When the power for conversion of the gas to plasma is the same level as applied in conventional parallel plated plasma CVD apparatus in thin film formation, the electrical potential of the plasma is suppressed to lower than the conventional level.

A film is formed in high density plasma while the electric potential of the plasma is suppressed from increase, so that a film of high quality can be formed at a high deposition rate.

Since the gas pressure in the space SP can be lowered, the film can be so suppressed from contamination with impurities. A film of high quality can be formed because of these advantages.

In the foregoing apparatus, the numbers of gas supply holes 210a, 210b (distribution density) and the area of opening of each hole are substantially uniform over the surface portion 210 as a whole. The distribution density of such gas supply holes and/or area of opening of the holes may be determined in such a way that the amount of gas blow is varied (e.g., increased or decreased) from a peripheral region to a central region of the gas supply surface portion 210 depending on the type of film to be formed or type of gas to be used.

Thereby the gas density is inclined so that the uniformity of film thickness may be further enhanced. The amount of gas blow may be continuously or stepwise varied (e.g., increased or decreased) or may be subjected to a combination of such variations from the peripheral region to the central region of the gas supply surface portion 210.

When a silicon film is formed using, e.g., silane (SiH₄) gas and hydrogen (H₂) gas, the uniformity of film thickness is further enhanced by decrease in the amount of gas blow from the central region to the peripheral region of the gas supply surface portion 210, in other words, by increase in the amount of gas blow from the peripheral region to the central region of the gas supply surface portion 210.

When a silicon oxide film is formed using, e.g., silane (SiH₄) gas and oxygen (O₂) gas, the uniformity of film thickness is further enhanced by increase in the amount of gas blow from the central region to the peripheral region of the gas supply surface portion, in other words, by decrease in the amount of gas blow from the peripheral region to the central region of the gas supply surface portion 210.

When a silicon nitride film is formed using, e.g., silane (SiH₄) gas and ammonia (NH₃) gas, the uniformity of film thickness is further enhanced by increase in the amount of gas blow from the central region to the peripheral region of the gas supply surface portion 210, in other words, by decrease in the amount of gas blow from the peripheral region to the central region of the gas supply surface portion 210.

In the aforesaid thin film-forming apparatus, a plurality of kinds of gases can be fed with use of a plurality of gas ducts. A gas duct of a single type duct system (duct 23 or 24 in the example in FIG. 1) may be used for feed of gas(es) if no problem arises. Gases which can be supplied in mixture may be fed as a mixture.

When a silicon film is formed using silane (SiH₄) gas and hydrogen (H₂) gas, or when a silicon nitride film is formed using silane (SiH₄) gas and ammonia (NH₃) gas, these gases may be fed separately or in mixture. When a silicon oxide film is formed using silane (SiH₄) gas and oxygen (O₂) gas, feed of these gases as mixed is likely to create silicon oxide particles. Thus separate feed thereof is desirable.

When the substrate S is heated to approximately 200° C. to 400° C in forming a silicon film, silicon oxide film or silicon nitride film, the film can be smoothly formed.

The gas pressure in the space SP is, for example, approximately 10⁻² Pa to 10 Pa, preferably approximately 0.2 Pa to 2 Pa in forming a silicon film; it is, for example, approximately 10⁻² Pa to 10 Pa, preferably 1 Pa to 10 Pa in forming a silicon oxide film; or it is, for example, approximately 10⁻² Pa to 10 Pa, preferably 1 Pa to 10 Pa in forming a silicon nitride film.

The foregoing thin film forming apparatus is adapted to introduce two kinds of gases, but may be adapted to introduce 3 or more kinds of gases depending on the kind of film to be formed.

In the foregoing thin film forming apparatus, 4 electrodes 41 are used as a power applying electrode for applying an electric power, but an electrode for introducing a high frequency is not limited thereto.

An electrode for applying a power may be of one-piece type (e.g., one piece in a cylindrical shape) or may be of the type consisting of a plurality of divided type, the divided electrodes may be arranged to surround the space SP in its entirety or substantially in its entirety, or may be arranged to be partially opposed to the space SP.

In the case of divided electrodes for applying a power, when a plurality of high frequency power sources are used as described above, the plasma density may be different between a central region of the space SP and a peripheral region thereof although depending on the type of the plasma. Against such possibility, a high frequency power source capable of applying high frequency power of pulse modulation may be used to obtain uniform plasma. The frequency of such pulse modulation may be, e.g., about 1 KHz to about 300 KHz.

Described below are Experimental Examples and Comparative Experimental Examples in which films were experimentally formed using the thin film forming apparatus of the type shown in FIG. 1. In any experiment, the gas supply member 21 in the shape of a plate measured 700 mm×840 mm was used. The support 5 serving also as a grounded electrode measured 650 mm×780 mm. The distance between the article to be film-covered at the film-forming position and the member 21 was about 150 mm. A plurality of kinds of gases were fed as a mixture of gases through the duct of a single type duct system according to the experiment, or fed as separated gases through the ducts of a dual type duct system as shown in FIG. 1.

### EXPERIMENTAL EXAMPLE 1-1

### Formation of Silicon Film

Article to be film-covered:

Alkali-free glass plate (measuring 600 mm×720 mm)

Film-forming gas:

SiH₄ 100 sccm, H₂ 150 sccm Fed through a duct of a single type duct system (duct 23 shown in FIG. 1)

Gas supply hole 210a of the member 21:

internal diameter 0.7 mm

Distribution density of gas supply holes in the member21:

(uniformly in entirety) 0.1 holes/cm²

Power for forming plasma:

high frequency power of 60 MHz Applied from the circumference of space SP with use of the electrodes 41

Gas pressure in the space SP:

0.7 Pa

Temperature for forming a film:

400° C.

Thickness of the film:

50 nm (deposition rate 10 nm/min)

### EXPERIMENTAL EXAMPLE 1-2

### Formation of Silicon Film

A silicon film was formed in the same manner as in Experimental Example 1-1 except that the distribution density of gas supply holes in the member 21 was 0.1 holes/cm² in the central region, was gradually decreased toward the periphery region and was 0.07 holes/cm² in the periphery region.

### COMPARATIVE EXPERIMENTAL EXAMPLE 1

### Formation of Silicon Film

Article to be film-covered:

Alkali-free glass plate (measuring 600 mm×720 mm)

Film-forming gas:

SiH₄ 100 sccm, H₂ 150 sccm Fed through a duct of a single type duct system (duct 23 shown in FIG. 1)

Gas supply hole 210a of the member 21:

internal diameter 0.7 mm

Distribution density of gas supply holes in the member 21:

(uniformly in entirety) 0.1 holes/cm²

Power for forming plasma:

high frequency power of 60 MHz Applied from the gas supply member 21

Gas pressure in the space SP:

25 Pa

Temperature for forming a film:

400° C.

Thickness of the film:

50 nm (deposition rate 10 nm/min)

### EXPERIMENTAL EXAMPLE 2-1

### Formation of Silicon Oxide Film

Article to be film-covered:

N-type silicon wafer (size: 4 inches in diameter)

Film-forming gas:

SiH₄ 300 sccm (fed through the duct 23) O₂ 1000 sccm (fed through the duct 24)

SiH₄ gas supply hole 210a of the member 21:

internal diameter 0.7 mm

O₂ gas supply hole 210b of the member 21: internal diameter 1.4 mm

Distribution density of gas supply holes of the member 21:

(SiH₄ gas supply hole and O₂ gas supply hole both uniformly in entirety) 0.1 holes/cm²

Power for forming plasma:

high frequency power of 60 MHz Applied from the circumference of the space SP with use of electrodes 41

Gas pressure in the space SP:

2.5 Pa

Temperature for forming a film:

400° C.

Thickness of the film:

100 nm (deposition rate 100 nm/min)

### COMPARATIVE EXPERIMENTAL EXAMPLE 2

### Formation of Silicon Oxide Film

Article to be film-covered:

N-type silicon wafer (size: 4 inches in diameter)

Film-forming gas:

SiH₄ 300 sccm (fed through the duct 23) O₂ 1000 sccm (fed through the duct 24)

SiH₄ gas supply hole 210a of the member 21:

internal diameter 0.7 mm

O₂ gas supply hole 210b of the member 21:

internal diameter 1.4 mm

Distribution density of gas supply holes in the member 21:

(SiH₄ gas supply hole and O₂ gas supply hole both uniformly in entirety) 0.1 holes/cm²

Power for forming plasma:

high frequency power of 60 MHz Applied from the gas supply member 21

Gas pressure in the space SP:

30 Pa

Temperature for forming a film:

400° C.

Thickness of the film:

100 nm (deposition rate 100 nm/min)

### EXPERIMENTAL EXAMPLE 2-2

### Formation of Silicon Oxide Film

Article to be film-covered:

Alkali-free glass plate (measuring 600 mm×720 mm)

Film-forming gas:

SiH₄ 300 sccm (fed through the duct 23) O₂ 1000 sccm (fed through the duct 24)

SiH₄ gas supply hole 210a of the member 21:

internal diameter 0.7 mm

O₂ gas supply hole 210b of the member 21:

internal diameter 1.4 mm

Distribution density of gas supply holes in the member21:

(SiH₄ gas supply hole and O₂ gas supply hole both uniformly in entirety) 0.1 holes/cm²

Power for forming plasma:

high frequency power of 60 MHz Applied from the circumference of space SP with use of the electrodes 41

Gas pressure in the space SP:

2.5 Pa

Temperature for forming a film:

400° C.

Thickness of the film:

100 nm (deposition rate 100 nm/min)

### EXPERIMENTAL EXAMPLE 2-3

### Formation of Silicon Oxide Film

A silicon oxide film was formed in the same manner as in Experimental Example 2-2 except that the distribution density of gas supply holes of the member 21 was 0.05 holes/cm² in the central region, was gradually increased toward the periphery region and was 0.1 holes/cm² in the peripheral region.

### EXPERIMENTAL EXAMPLE 3-1

### Formation of Silicon Nitride Film

Article to be film-covered:

N-type silicon wafer (size: 4 inches in diameter)

Film-forming gas:

SiH₄ 100 sccm, NH₃ 250 sccm Fed through a single type duct system (duct 23 in FIG. 1)

Gas supply hole 210a of the member 21:

internal diameter 0.7 mm

Distribution density of gas supply holes of the member 21:

(uniformly in entirety) 0.1 holes/cm²

Power for forming plasma:

high frequency power of 60 MHz Applied from the circumference of space SP with use of the electrodes 41

Gas pressure in the space SP:

2.5 Pa

Temperature for forming a film:

400° C.

Thickness of the film:

100 nm (deposition rate 50 nm/min)

### EXPERIMENTAL EXAMPLE 3-2

### Formation of Silicon Nitride Film

A silicon nitride film was formed in the same manner as in Experimental Example 3-1 except that the distribution density of gas supply holes of the member 21 was 0.05 holes/cm² in the central region, was gradually increased toward the periphery region and was 0.1 holes/cm² in the peripheral region.

### COMPARATIVE EXPERIMENTAL EXAMPLE 3

### Formation of Silicon Nitride Film

Article to be film-covered:

N-type silicon wafer (size: 4inches in diameter)

Gas to be used:

SiH₄ 100 sccm, NH₃ 250 sccm Fed through a single type duct system (duct 23 in FIG. 1)

Gas supply hole 210a of the member 21:

internal diameter 0.7 mm

Distribution density of gas supply holes of the member 21:

(uniformly in entirety) 0.1 holes/cm²

Power for forming plasma:

high frequency power of 60 MHz Applied from the gas supply member 21

Gas pressure in the space SP:

30 Pa

Temperature for forming a film:

400° C.

Thickness of the film:

100 nm (deposition rate 50 nm/min)

The silicon films formed in Experimental Example 1-1 and Comparative Experimental Example 1 were evaluated by a Raman spectroscopic analysis device. The silicon film of Comparative Experimental Example 1 exhibited a broad peak at about 480 cm⁻¹ and was found amorphous. On the other hand, the silicon film of Experimental Example 1-1 exhibited a broad peak at about 480 cm⁻¹ but a peak showing crystallization was confirmed at about 520 cm⁻¹. That is, it was found that the silicon film of Comparative Experimental Example 1 was amorphous, whereas the silicon film of Experimental Example 1-1 was crystalline.

Aluminum (Al) was deposited on the silicon oxide films of Experimental Example 2-1 and Comparative Experimental Example 2 to give MOS structure, and then C-V characteristic and I-V characteristic were evaluated. The silicon oxide film of Comparative Experimental Example 2 exhibited a flat band voltage of −3.2V, an interface trap density of 1×10¹²/cm² eV, and a dielectric breakdown voltage of 6.7 MV/cm, whereas the silicon oxide film of Experimental Example 2-1 exhibited a flat band voltage of −0.2V, an interface trap density of 5×10¹¹/cm² eV, and a dielectric breakdown voltage of 8.1 MV/cm. The silicon oxide film of Experimental Example 2-1 was confirmed as a less defective and high-quality film.

Aluminum (Al) was deposited on the silicon nitride films of Experimental Example 3-1 and Comparative Experimental Example 3 to give MOS structure, and then C-V characteristic was evaluated. The film of Comparative Experimental Example 3 exhibited a flat band voltage of −4.1V, whereas the film of Experimental Example 3-1 exhibited a flat band voltage of −1.0 V. The film of Experimental Example 3-1 was confirmed as a less defective and high-quality film.

In Experimental Examples 1-1, 2-1, 2-2 and 3-1, the gas supply surfaces portion 210 of the member 21 had the same distribution density of gas supply holes and the same hole opening area. In Experimental Examples 1-2, 2-3, and 3-2, films were formed in such manner that the hole opening area was constant while the distribution density of gas supply holes was decreased from the central region to the peripheral region of the gas supply surface portion 210 in forming a silicon film, was increased from the central region to the peripheral region of the gas supply surface portion 210 in forming a silicon oxide film, and was increased from the central region to the peripheral region of the gas supply surface portion 210 in forming a silicon nitride film and the other conditions were the same as in Experimental Examples 1-1, 2-2, and 3-1, respectively. The obtained films were markedly uniform in film thickness.

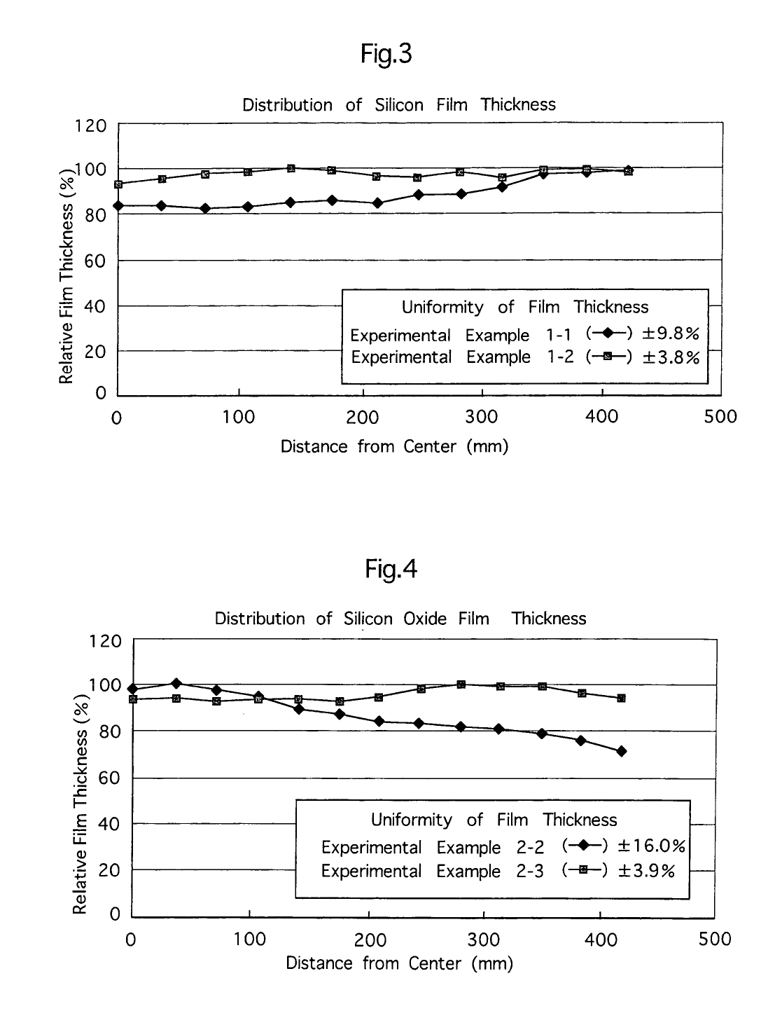

The uniformity of thickness of silicon films of Experimental Examples 1-1 and 1-2 was evaluated with the results shown in FIG. 3. The abscissa in FIG. 3 indicates a distance from a center of the glass substrate to be film-covered (600 mm×720 mm) toward one corner of the substrate, while the ordinate indicates a relative thickness based on a maximum thickness as 100.

In Experimental Example 1-1 wherein the distribution density of gas supply holes is substantially uniform, the film thickness is substantially uniform over a distance of about 250 mm from the center of the substrate, but the film thickness increases as the periphery of the substrate is approached therefrom, and the uniformity of thickness as a whole was ±9.8%. On the other hand, in Experimental Example 1-2 wherein the distribution density of gas supply holes was varied, the film thickness is substantially uniform as a whole and the uniformity of thickness was enhanced to ±3.8%.

As described above, it is clear that the uniformity of film thickness can be improved as the amount of gas to be fed is decreased from a central region to the peripheral region of the substrate to be film-covered in forming a silicon film.

In Experimental Example 1-2, the increase and decrease of amount of gas to be fed were adjusted by the number of gas supply holes (distribution density). But they may be done by adjusting the opening area of gas supply holes in place of or along with the distribution density of gas supply holes.

The uniformity of thickness of silicon oxide films of Experimental Examples 2-2 and 2-3 were evaluated with the results shown in FIG. 4. The abscissa in FIG. 4 indicates a distance from a center of the glass substrate to be film-covered (600 mm×720 mm) toward one corner of the substrate, while the ordinate indicates a relative thickness based on a mamimum thickness as 100.

In Experimental Example 2-2 wherein the distribution density of gas supply holes is uniform as a whole, the film thickness is decreased from a center of the substrate to a periphery thereof and the uniformity of film thickness as a whole was ±16.0%.

On the other hand, in Experimental Example 2-3 wherein the distribution density of gas supply holes was varied, the film thickness is substantially uniform as a whole and the uniformity of thickness was enhanced to ±3.9%.

As described above, it is clear that the uniformity of film thickness can be improved as the amount of gas to be fed is increased from the central region to the peripheral region of the substrate to be film-covered in forming a silicon oxide film. In Experimental Example 2-3, the increase and decrease of amount of gas to be fed were adjusted by the number of gas supply holes (distribution density) but may be done by adjusting the opening area of gas supply holes in place of the distribution density of gas supply holes or along with the distribution density thereof.

In the silicon nitride films of Experimental Examples 3-1 and 3-2, the distribution of film thickness shows the same tendency as the silicon oxide films, and the uniformity of film thickness was improved by increasing the amount of gas to be fed from the center of the substrate to be film-covered to the periphery thereof.

As explained above, the invention can provide an apparatus for forming a thin film, wherein a film-forming gas is supplied from a gas supplying device to a vacuum container which can be evacuated by an exhausting device to reduce gas pressure in the container, and a power is applied to the film-forming gas from a power applying device to convert the gas into plasma in which a thin film is formed on an article to be film-covered disposed in the vacuum container, the apparatus being capable of forming a thin film of high quality at a high deposition rate by increasing the plasma density without raising the electrical potential of the plasma; and a method for forming a thin film using the above-mentioned apparatus, the method being capable of forming a thin film of high quality at a high deposition rate by increasing the plasma density without raising the electrical potential of the plasma.

According to the invention, there are also provided such thin film forming apparatus and such method for forming a thin film, the apparatus and the method being capable of forming a thin film of uniform thickness.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An apparatus for forming a thin film, wherein a film-forming gas is supplied from a gas supplying device to a vacuum container which can be evacuated by an exhausting device to reduce gas pressure in the container, an electric power is applied from a power applying device to the film-forming gas to produce plasma from the gas in which a thin film is formed on an article to be film-covered disposed in the vacuum container, the gas supplying device including a gas supply member having a gas supply surface portion, the gas supply surface portion being opposed to a film-forming surface of the article to be film-covered disposed in the vacuum container, the power applying device including a power applying electrode disposed in the vacuum container, the gas supply member having a plurality of gas supply holes dispersedly formed at the gas supply surface portion, the power applying electrode being disposed in a surrounding region around a space between the article to be film-covered disposed in the vacuum container and the gas supply surface portion of the gas supply member opposed to the article.

2. An apparatus according to claim 1, wherein the exhausting device discharges a gas from a region of vicinity of periphery portion of the gas supply member.

3. An apparatus according to claim 1, wherein the power applying device includes 4 divided electrodes as the power applying electrode for applying the electric power and high frequency power sources each connected to the divided electrodes, respectively, each of the divided electrodes is in a shape of a bent plate, the divided electrodes being disposed in a quadrilateral shape in a plan view surrounding the space between the article to be film-covered in the vacuum container and the gas supply surface portion of the gas supply member opposed to the article.

4. An apparatus according to claim 1, wherein distribution density of the gas supply holes in the gas supply surface portion of the gas supply member and area of opening of the holes are determined in such a way that amount of gas blow from the gas supply surface portion is varied from a peripheral region to a central region of the gas supply surface portion.

5. A method for forming a thin film on an article to be covered with the film, using the apparatus as claimed in claim 1, wherein the thin film is formed while retaining gas pressure in the space at 10⁻² Pa to 10 Pa during formation of the film.

6. A method according to claim 5, wherein the exhausting device is of the type wherein a gas is discharged from a region of vicinity of periphery portion of the gas supply member.

7. A method according to claim 5, wherein distribution density of the gas supply holes in the gas supply surface portion of the gas supply member and area of opening of the holes are determined in such a way that amount of gas blow from the gas supply surface portion is varied from a peripheral region to a central region of the gas supply surface portion.

8. A method for forming a thin film on an article to be covered with the film, using the apparatus as claimed in claim 1, wherein at least silane (SiH₄) gas and hydrogen (H₂) gas are used as the film-forming gas, wherein distribution density of the gas supply holes in the gas supply surface portion of the gas supply member and the area of opening of the holes are determined in such a way that amount of gas blow from the gas supply surface portion is increased from a peripheral region to a central region of the gas supply surface portion and wherein a crystalline silicon film is formed on the article while retaining gas pressure in the space at 10⁻² Pa to 10 Pa during formation of the film.

9. A method according to claim 8, wherein the exhausting device is of the type wherein a gas is discharged from a region of vicinity of periphery portion of the gas supply member.

10. A method for forming a thin film on an article to be covered with the film, using the apparatus as claimed in claim 1, wherein at least silane (SiH₄) gas and oxygen (O₂) gas are used as the film-forming gas, wherein the gas supplying device is of the type wherein the gases are introduced in a separated state into the gas supply surface portion of the gas supply member, distribution density of the gas supply holes in the gas supply surface portion of the gas supply member and area of opening of the holes are determined in such a way that amount of gas blow from the gas supply surface portion is decreased from a peripheral region to a central region of the gas supply surface portion and wherein a silicon oxide film is formed on the article while retaining gas pressure in the space at 10⁻² Pa to 10 Pa during the formation of the film.

11. A method according to claim 10, wherein the exhausting device is of the type wherein a gas is discharged from a region of vicinity of periphery portion of the gas supply member.

12. A method for forming a thin film on an article to be covered with the film, using the apparatus as claimed in claim 1, wherein at least silane (SiH₄) gas and ammonia (NH₃) gas are used as the film-forming gas, wherein distribution density of the gas supply holes in the gas supply surface portion of the gas supply member and area of opening of the holes are determined in such a way that amount of gas blow from the gas supply surface portion is decreased from a peripheral region to a central region of the gas supply surface portion and wherein a silicon nitride film is formed on the article while retaining gas pressure in the space at 10⁻² Pa to 10 Pa during formation of the film.

13. A method according to claim 12, wherein the exhausting device is of the type wherein a gas is discharged from a region of vicinity of periphery portion of the gas supply member.
